(19) United States
(12) Patent Application Publication
(10) Pub. No.: US 2023/0196810 A1
(43) Pub. Date: Jun. 22, 2023

(54) NEURAL ODE-BASED CONDITIONAL TABULAR GENERATIVE ADVERSARIAL NETWORK APPARATUS AND METHOD

(71) Applicant: UIF (University Industry Foundation), Yonsei University, Seoul (KR)

(72) Inventors: No Seong PARK, Seoul (KR); Ja Young KIM, Seoul (KR); Jin Sung JEON, Seoul (KR); Jae Hoon LEE, Tongyeong-si (KR); Ji Hyeon HYEONG, Jeju-si (KR)

(73) Assignee: UIF (University Industry Foundation), Yonsei University, Seoul (KR)

(21) Appl. No.: 17/564,870

(22) Filed: Dec. 29, 2021

(30) Foreign Application Priority Data
Dec. 17, 2021 (KR) 10-2021-0181679

(51) Int. Cl. G06V 30/19; G06N 3/04; G06F 17/13

(52) U.S. Cl. CPC G06V 30/19147; G06N 3/0454; G06F 17/13

(57) ABSTRACT

A neural ODE-based conditional tabular generative adversarial network apparatus includes: a tabular data preprocessing unit for preprocessing tabular data composed of a discrete column and a continuous column; a Neural Ordinary Differential Equation (NODE)-based generation unit for generating a fake sample by reading a condition vector and a noisy vector generated based on the preprocessed tabular data; and a NODE-based discrimination unit for receiving a sample composed of a real sample or the fake sample of the preprocessed tabular data and performing continuous trajectory-based classification.

### ACKNOWLEDGEMENT

### National R&D Project Supporting the Present Invention

Assignment number: 1711126082

Project number: 2020-0-01361-002

Department name: Ministry of Science and Technology Information and Communication

Research and management institution: Information and Communication Planning and Evaluation Institute

Research project name: Information and Communication Broadcasting Innovation Talent Training(R&D)

Research project name: Artificial Intelligence Graduate School Support(Yonsei University)

Contribution rate: 1/1

Organized by: Yonsei University Industry-Academic Cooperation Foundation

Research period: 20210101 to 20211231

### CROSS-REFERENCE TO RELATED APPLICATION

This application claims priority to Korean Patent Application No. 10-2021-0181679 (filed on Dec. 17, 2021), which is hereby incorporated by reference in its entirety.

### BACKGROUND

The present disclosure relates to data synthesis technology, and more particularly, to a neural ODE-based conditional tabular generative adversarial network apparatus and method capable of additionally synthesizing tabular data using a generative adversarial neural model based on neural ODE.

Many web-based application programs use tabular data, and many enterprise systems use relational database management systems. For these reasons, many web-oriented researchers focus on various tasks on tabular data. In other words, it may be very important to generate realistic synthetic tabular data in these tasks. If the utility of synthetic data is reasonably high while being different enough from real data, it may greatly benefit many applications by enabling to use synthetic data as training data.

Generative Adversarial Networks (GANs), which consist of a generator and a discriminator, may be one of the most successful generative models. GANs have been extended to various domains, ranging from images and texts to tables. Recently, a tabular GAN, called TGAN, has been introduced to synthesize tabular data. TGAN may show the state-of-the-art performance among existing GANs in generating tables in terms of model compatibility. In other words, a machine learning model trained with synthetic (generated) data may show reasonable accuracy for unknown real test cases.

On the other hand, tabular data often has an irregular distribution and multimodality, and existing techniques may not work effectively.

### RELATED ART DOCUMENT

### Patent Document

Korean Patent Application Publication No. 10-2021-0098381; Aug. 10, 2021

### SUMMARY

In an embodiment of the present disclosure, there is provided a neural ODE-based conditional tabular generative adversarial network apparatus and method capable of additionally synthesizing tabular data using a generative adversarial neural model based on neural ODE.

Among embodiments, the Neural ODE-based Conditional Tabular Generative Adversarial Network (OCT-GAN) apparatus includes: a tabular data preprocessing unit for preprocessing tabular data composed of a discrete column and a continuous column; a Neural Ordinary Differential Equation (NODE)-based generation unit for generating a fake sample by reading a condition vector and a noisy vector generated based on the preprocessed tabular data; and a NODE-based discrimination unit for receiving a sample composed of a real sample or the fake sample of the preprocessed tabular data and performing continuous trajectory-based classification.

The tabular data preprocessing unit may transform discrete values in the discrete column into a one-hot vector and preprocess continuous values in the continuous column with mode-specific normalization.

The tabular data preprocessing unit may generate a normalized value and a mode value by applying a Gaussian mixture to each of the continuous values and normalizing the same with a corresponding standard deviation.

The tabular data preprocessing unit may transform raw data in the tabular data into mode-based information by merging the one-hot vector, the normalized value, and the mode value.

The NODE-based generation unit may obtain the condition vector from a condition distribution, obtain the noisy vector from a Gaussian distribution, and generate the fake sample by merging the condition vector and the noisy vector.

The NODE-based generation unit may perform homeomorphic mapping on the merged vector of the condition vector and the noisy vector to generate the fake sample within a range that matches a distribution of a real sample.

The NODE-based discrimination unit may perform feature extraction of the input sample and generate a plurality of continuous trajectories through Ordinary Differential Equations (ODE) on the feature-extracted sample.

The NODE-based discrimination unit may generate a merged trajectory hx by merging the plurality of continuous trajectories, and classify the sample as real or fake through the merged trajectory.

Among the embodiments, the Neural ODE-based Conditional Tabular Generative Adversarial Network (OCT-GAN) method includes: a tabular data preprocessing stage of preprocessing tabular data composed of a discrete column and a continuous column; a Neural Ordinary Differential Equation (NODE)-based generation stage of generating a fake sample by reading a condition vector and a noisy vector generated based on the preprocessed tabular data; and a NODE-based discrimination stage of receiving a sample composed of a real sample or the fake sample of the preprocessed tabular data and performing continuous trajectory-based classification.

The tabular data preprocessing stage may include transforming discrete values in the discrete column into a one-hot vector and preprocessing continuous values in the continuous column with mode-specific normalization.

The NODE-based generation stage may include obtaining the condition vector from a condition distribution, obtaining the noisy vector from a Gaussian distribution, and generating the fake sample by merging the condition vector and the noisy vector.

The NODE-based generation stage may include performing homeomorphic mapping on the merged vector of the condition vector and the noisy vector to generate the fake sample within a range that matches a distribution of a real sample.

The NODE-based discrimination stage may include performing feature extraction of the input sample and generating a plurality of continuous trajectories through Ordinary Differential Equations (ODE) on the feature-extracted sample.

The disclosed technology may have the following advantages. However, it does not mean that a specific embodiment should include all of or only the following advantages. Therefore, it should not be understood that the scope of right of the disclosed technology is not limited to the following.

A neural ODE-based conditional tabular generative adversarial network apparatus and method according to the present disclosure can additionally synthesize tabular data using a generative adversarial neural model based on neural ODE.

### BRIEF DESCRIPTION OF THE DRAWINGS

FIG. 1 is a diagram illustrating an OCT-GAN system according to the present disclosure.

FIG. 2 is a diagram illustrating the system configuration of the OCT-GAN apparatus according to the present disclosure.

FIG. 3 is a diagram illustrating the functional configuration of the OCT-GAN apparatus according to the present disclosure.

FIG. 4 is a flowchart illustrating a neural ODE-based conditional tabular generative adversarial network method according to the present disclosure.

FIGS. 5 and 6 are diagrams illustrating a detailed design of the neural ODE-based conditional tabular generative adversarial network method according to the present disclosure.

FIG. 7 is a diagram illustrating the neural ODE-based conditional tabular generative adversarial network method according to the present disclosure.

FIG. 8 is a diagram illustrating a two-stage approach according to the present disclosure.

FIG. 9 is a diagram illustrating the learning algorithm of OCT-GAN according to the present disclosure.

FIGS. 10 to 14 are diagrams illustrating experimental results of the neural ODE-based conditional tabular generative adversarial network method according to the present disclosure.

### DETAILED DESCRIPTION

Explanation of the present disclosure is merely an embodiment for structural or functional explanation, so the scope of the present disclosure should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present disclosure, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a,” “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

In each stage, reference numerals (for example, a, b, c, etc.) are used for the sake of convenience in description, and such reference numerals do not describe the order of each stage. The order of each stage may vary from the specified order, unless the context clearly indicates a specific order. In other words, each stage may take place in the same order as the specified order, may be performed substantially simultaneously, or may be performed in a reverse order.

The present disclosure may be implemented as machine-readable codes on a machine-readable medium. The machine-readable medium may include any type of recording device for storing machine-readable data. Examples of the machine-readable recording medium may include a read-only memory (ROM), a random access memory (RAM), a compact disk-read only memory (CD-ROM), a magnetic tape, a floppy disk, optical data storage, or any other appropriate type of machine-readable recording medium. The medium may also be carrier waves (e.g., Internet transmission). The computer-readable recording medium may be distributed among networked machine systems which store and execute machine-readable codes in a de-centralized manner.

The terms used in the present application are merely used to describe particular embodiments, and are not intended to limit the present disclosure. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present application.

A Generative Adversarial Network (GAN) may consist of two neural networks: a generator and a discriminator. The generator and discriminator may perform a two-play zero-sum game, and each equilibrium state may be theoretically defined. Herein, the generator may achieve optimal generation quality, and the discriminator may not be able to distinguish between real and fake samples. WGAN and its variants are widely used among many GANs proposed so far. In particular, WGAN-GP may be one of the most successful models, and may be expressed as Equation 1 below.

$${min}_{G} {max}_{D} {𝔼 [ D ( x ) ]}_{x \sim {p}_{x}} - {𝔼 [ D ( G ( z ) ) ]}_{z \sim {p}_{z}} - {λ𝔼 [ {( {‖ {∇}_{\overline{x}} D ( \overline{x} ) ‖}_{2} - 1 )}^{2} ]}_{\overline{x} \sim {p}_{\overline{x}}} \qquad [ Equation 1 ]$$

Herein, p_{z} is a prior distribution, pₓ is a distribution of data, G is a generator function, D is a discriminator function (or Wasserstein critic), x̅ is a randomly weighted combination of G(z) and x. The discriminator may provide feedback on the quality of the generation. In addition, p_{g} may be defined as a distribution of fake data induced by the function G(z) from p_{z}, and p_{x̅} may be defined as a distribution created after the random combination. In general, N(0,1) may be used for the prior distribution p_{z}. Many task-specific GAN models may be designed based on a WGAN-GP framework. [symbol] _{D} and [symbol] _{G} to denote loss functions of the WGAN-GP may be used to train the discriminator and the generator, respectively.

In addition, a conditional GAN (CGAN) may be one of the common variants of the GAN. In the conditional GAN scheme, the generator G(z,c) may be provided with a noisy vector z and a condition vector c. In this connection, the condition vector may correspond to a one-hot vector indicating a class label to be generated.

Tabular data synthesis, which generates a realistic synthetic table by modeling a joint probability distribution of columns in a table, may encompass many different methods depending on the types of data. For instance, Bayesian networks and decision trees may be used to generate discrete variables. A recursive modeling of tables using the Gaussian copula may be used to generate continuous variables. A differentially private information protection algorithm for decomposition may be used to synthesize spatial data.

However, some constraints such as the type of distributions and computational problems of these models may have hampered high-fidelity data synthesis.

In recent years, several data generation methods based on GANs have been introduced as a method of synthesizing tabular data, which mostly handle healthcare records. RGAN may generate continuous time-series healthcare records, while MedGAN and corrGAN may generate discrete records. EhrGAN may generate plausible labeled records using semi-supervised learning to augment limited training data. PATE-GAN may generate synthetic data without endangering the privacy of original data. TableGAN may improve tabular data synthesis using convolutional neural networks to maximize the prediction accuracy on the label column.

h(t) may be defined as a function that outputs a hidden vector at time (or layer) t in a neural network. In Neural OEDs (NODEs), a neural network f with a set of parameters, denoted θ_{f}, may approximate

$$\frac{dh ( t )}{dt} .$$

In addition, h(tₘ) may be calculated by h(t₀)+∫ₜ_{₀}^{t}^{ₘ}f(h(t), t; θ_{f})dt, where

$$f ( h ( t ) , t ; {θ}_{f} ) = \frac{dh ( t )}{dt} .$$

In other words, the internal dynamics of the hidden vector evolution process may be described by a system of ODEs parameterized by θ_{f}. When NODEs are used, t may be interpreted as continuous, which may be discrete in usual neural networks. Therefore, more flexible constructions may be possible in NODEs, which is one of the main reasons for adopting an ODE layer in the discriminator in the present disclosure.

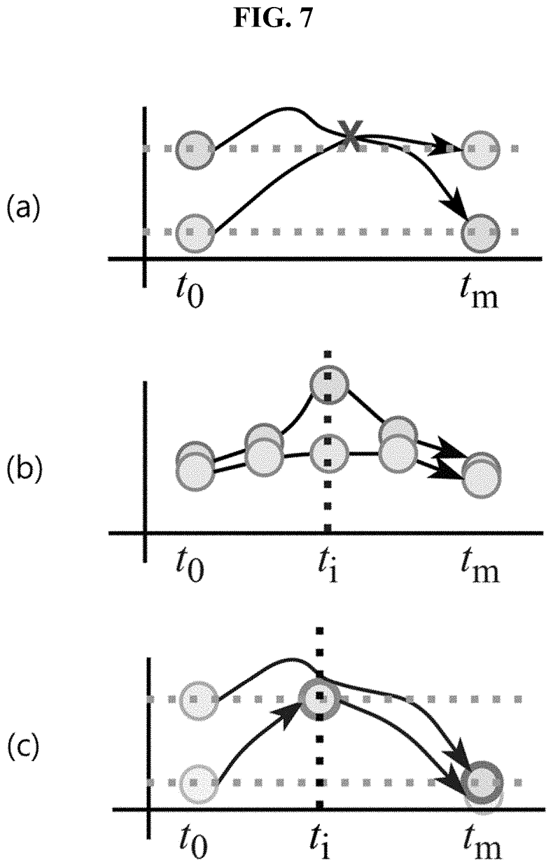

To solve the integral problem, h(t₀)+∫ₜ_{₀}^{t}^{ₘ}f(h(t), t; θ_{f})dt, in NODEs, an ODE solver may transform an integral into a series of additions. The Dormand-Prince (DOPRI) method may be one of the most powerful integrators and may be widely used in NODEs. DOPRI may dynamically control its stage size while solving the integral problem. ϕₜ: [symbol] → [symbol] may be defined as a mapping from t₀ to tₘ created by an ODE after solving the integral problem. ϕₜ may be a homeomorphic mapping. ϕₜ may be continuous and bijective, and ϕₜ⁻¹ may also be continuous for all t∈[0,T], where T is the last time point of the time domain. From this characteristic, the following proposition may be derived. In other words, the topology of the input space of ϕₜ is preserved in the output space, and therefore, trajectories crossing each other may not be represented by NODEs (see FIG. 7(A)).

While preserving the topology, NODEs may perform machine learning tasks, and may increase the robustness of representation learning to adversarial attacks. Instead of the backpropagation method, the adjoint sensitivity method may be used to train NODEs for its efficiency and theoretical correctness. After letting

$${a}_{h} ( t ) = \frac{d ℒ}{dh ( t )}$$

for a task-specific loss L, the gradient of the loss w.r.t model parameters may be calculated with another reverse-mode integral as shown in Equation 2 below.

$${∇}_{{θ}_{f}} ℒ = \frac{d ℒ}{d {θ}_{f}} = - {\int }_{{t}_{m}}^{{t}_{0}} {{a}_{h} ( t )}^{T} \frac{\partial f ( h ( t ) , t ; {θ}_{f} )}{\partial {θ}_{f}} dt \qquad [ Equation 2 ]$$

∇ₕ₍₀₎ [symbol] may also be calculated in a similar way, and the gradient may be propagated backward to layers earlier than the ODE if any. The space complexity of the adjoint sensitivity method is O(1), whereas using the backpropagation to train NODEs may have a space complexity proportional to the number of DOPRI stages. The time complexity may be similar to each other, or the adjoint sensitivity method may be slightly more efficient than that of the backpropagation method. Accordingly, the NODE may be effectively trained.

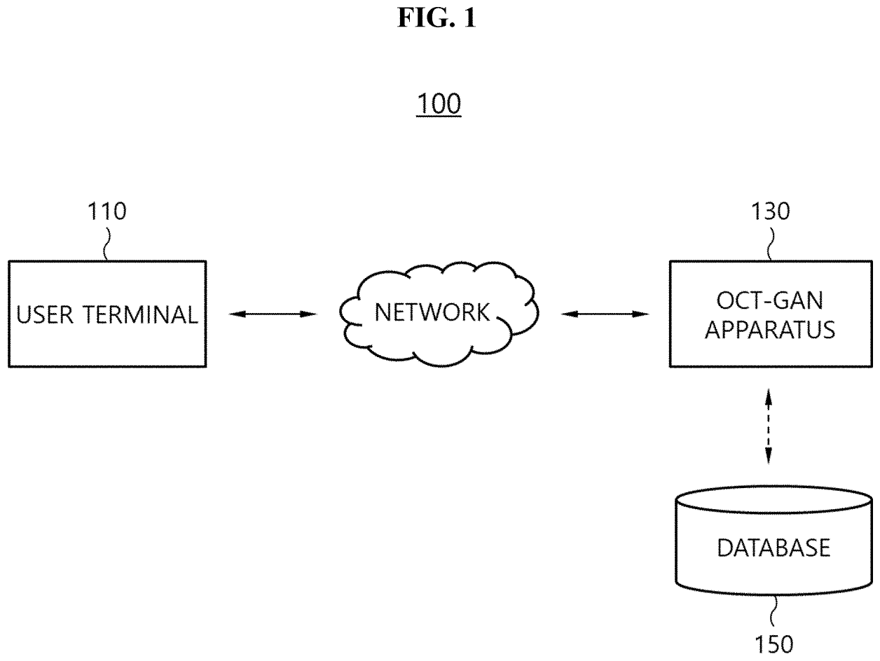

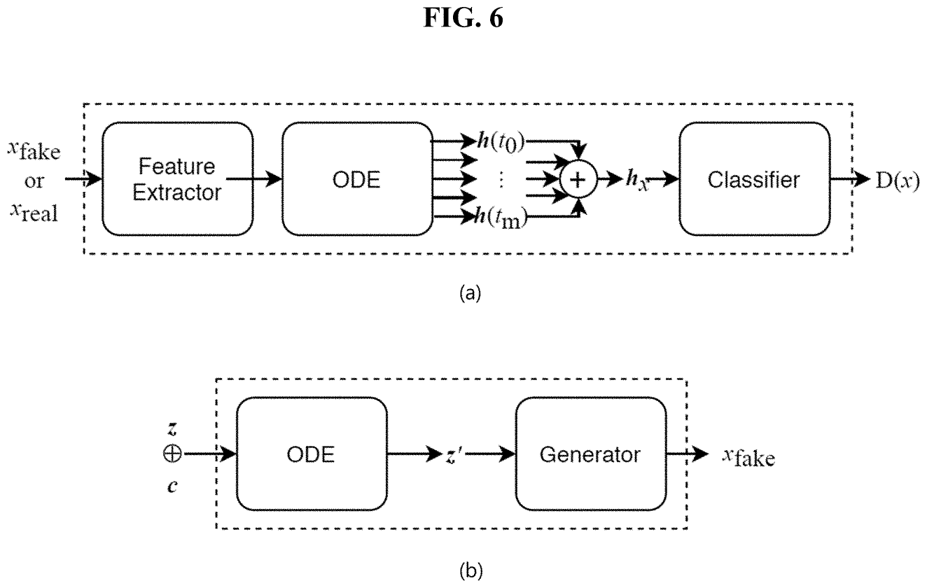

Hereinafter, an OCT-GAN apparatus and method according to the present disclosure will be described in more detail with reference to FIGS. 1 to 9.

FIG. 1 is a diagram illustrating an OCT-GAN system according to the present disclosure.

Referring to FIG. 1, an OCT-GAN system 100 may be implemented to execute a neutral ODE-based conditional tabular generative adversarial network method according to the present disclosure. To this end, the OCT-GAN system 100 may include a user terminal 110, an OCT-GAN apparatus 130, and a database 150.

The user terminal 110 may correspond to a terminal device operated by a user. For example, the user may process an operation related to data generation and learning through the user terminal 110. In an embodiment of the present disclosure, a user may be understood as one or more users, and a plurality of users may be divided into one or more user groups.

In addition, the user terminal 110 is a device constituting the OCT-GAN system 100 and may correspond to a computing device that operates in conjunction with the OCT-GAN apparatus 130. For example, the user terminal 110 may be implemented as a smartphone, a notebook computer, or a computer that is connected to the OCT-GAN apparatus 130 and is operable, and is not necessarily limited thereto, and may be implemented in various devices including a tablet PC. In addition, the user terminal 110 may install and execute a dedicated program or application for interworking with the OCT-GAN apparatus 130.

The OCT-GAN apparatus 130 may be implemented as a server corresponding to a computer or program performing the neutral ODE-based conditional tabular generative adversarial network method according to the present disclosure. In addition, the OCT-GAN apparatus 130 may be connected to the user terminal 110 and a wired network or a wireless network such as Bluetooth, WiFi, LTE, etc., and may transmit/receive data to and from the user terminal 110 through the network. In addition, the OCT-GAN apparatus 130 may be implemented to operate in connection with an independent external system (not shown in FIG. 1) in order to perform a related operation.

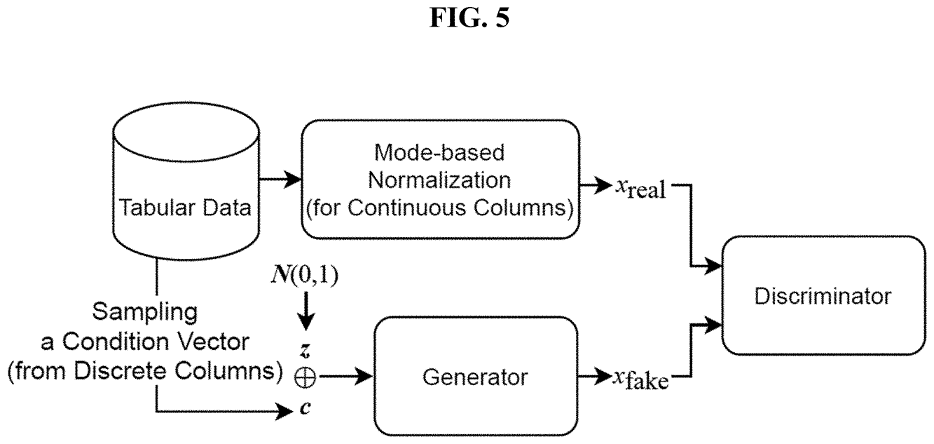

FIG. 5 illustrate a detailed design of the neural ODE-based conditional tabular generative adversarial network method, that is, the NODE-based Conditional Tabular GAN (OCT-GAN) according to the present disclosure. In other words, in NODEs, a neural network f may learn a system of ordinary differential equations to approximate dh(t)/dt, where h(t) is a hidden vector at time (or layer) t. Given a sample x (i.e., a row or record in a table), an integral problem, i.e., h(tₘ)=h(t₀)+∫ₜ_{₀}^{t}^{ₘ}f(h(t), t; θ_{f})dt, is solved, where θ_{f} means a set of parameters to learn for f. NODEs may convert the integral problem into multiple stages of additions and extract a trajectory from those stages, i.e., {h(t₀), h(t₁), (t₂), . . . , h(tₘ)}. The discriminator equipped with a learnable ODE according to the present disclosure may utilize the extracted evolution trajectory to distinguish between real and synthetic samples (whereas other neural networks use only the last hidden vector, e.g., h(tₘ) in the above example). This trajectory-based classification according to the present disclosure brings non-trivial freedom to the discriminator, making it be able to provide better feedback to the generator. Additional key part of the method according to the present disclosure may be a method of deciding those time points tᵢ, for all i, to extract trajectories. The method according to the present disclosure allows the model to learn from data.

The database 150 may correspond to a storage device for storing various types of information required in the operation process of the OCT-GAN apparatus 130. For example, the database 150 may store information about learning data used in a learning process, and may store information about a model or a learning algorithm for learning, but is not necessarily limited thereto. The OCT-GAN apparatus 130 may store information collected or processed in various forms while performing the neutral ODE-based conditional tabular generative adversarial network method according to the present disclosure.

In FIG. 1, the database 150 is illustrated as an apparatus independent of the OCT-GAN apparatus 130, but is not necessarily limited thereto, and may be implemented by being included in the OCT-GAN apparatus 130 as a logical storage device.

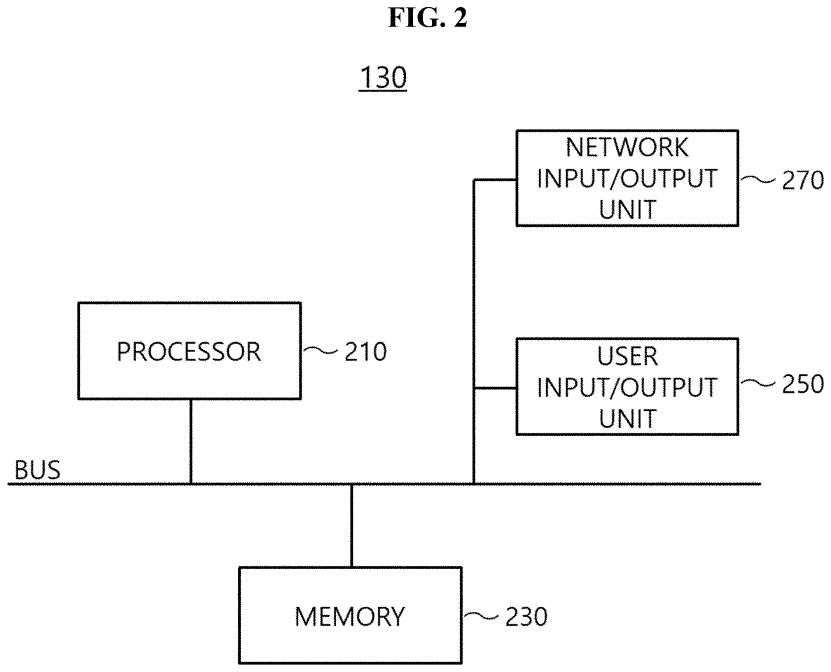

FIG. 2 is a diagram illustrating the system configuration of the OCT-GAN apparatus according to the present disclosure.

Referring to FIG. 2, the OCT-GAN apparatus 130 may include a processor 210, a memory 230, a user input/output unit 250, and a network input/output unit 270.

The processor 210 may execute the neutral ODE-based conditional tabular generative adversarial network procedure according to the present disclosure, manage the memory 230 that is read or written in this process, and schedule synchronization time between a volatile memory and a non-volatile memory in the memory 230. The processor 210 may control the overall operation of the OCT-GAN apparatus 130, and is electrically connected to the memory 230, the user input/output unit 250, and the network input/output unit 270 to control data flow therebetween. The processor 210 may be implemented as a central processing unit (CPU) of the OCT-GAN apparatus 130.

The memory 230 may include an auxiliary memory unit implemented with a nonvolatile memory such as a Solid State Disk (SSD) or a Hard Disk Drive (HDD) and used for storing entire data necessary for the OCT-GAN apparatus 130 and include a main memory unit implemented with a volatile memory such as a Random Access Memory (RAM). In addition, the memory 230 may store a set of instructions for executing the neutral ODE-based conditional tabular generative adversarial network method according to the present disclosure by being executed by the electrically connected processor 210.

The user input/output unit 250 may include an environment for receiving a user input and an environment for outputting specific information to a user, and includes, for example, an input device including an adapter such as a touch pad, a touch screen, an on-screen keyboard, or a pointing device and an output device including an adapter such as a monitor or a touch screen. In an embodiment, the user input/output unit 250 may correspond to a computing device accessed through remote access, and in such a case, the OCT-GAN apparatus 130 may be implemented as an independent server.

The network input/output unit 270 may provide a communication environment to be connected to the user terminal 110 through a network, for example, it may include an adapter for communication such as a local area network (LAN), a metropolitan area network (MAN), a wide area network (WAN) and a value added network (VAN). In addition, the network input/output unit 270 may be implemented to provide a short-distance communication function such as WiFi or Bluetooth or a wireless communication function such as 4G or beyond for wireless data transmission.

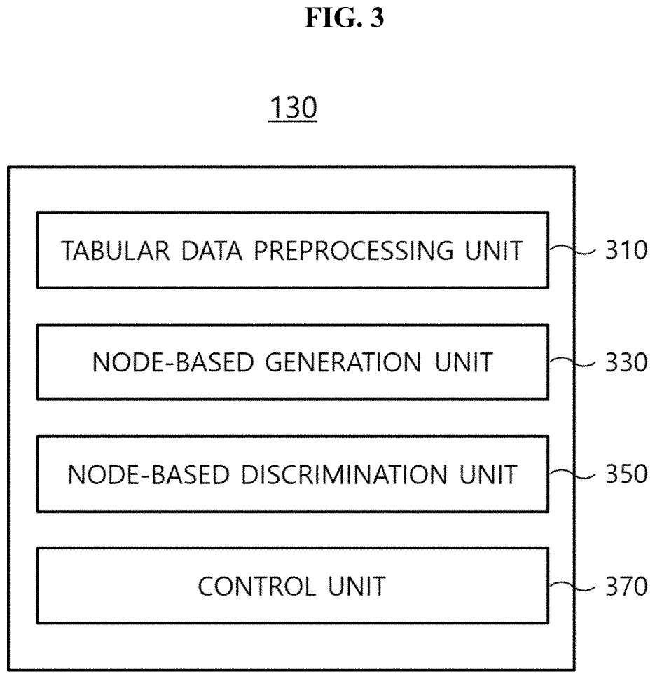

FIG. 3 is a diagram illustrating the functional configuration of the OCT-GAN device according to the present disclosure.

Referring to FIG. 3, the OCT-GAN apparatus 130 may include a tabular data preprocessing unit 310, a NODE-based generation unit 330, a NODE-based discrimination unit 350, and a control unit 370. The OCT-GAN apparatus 130 may apply an ODE layer to the NODE-based generation unit 330 and the NODE-based discrimination unit 350.

Thus, the OCT-GAN apparatus 130 may interpret time (or layer) t as continuous in the ODE layer through the discrimination unit 350. In addition, the OCT-GAN apparatus 130 may perform trajectory-based classification by finding optimal time points that lead to improved classification performance.

In addition, the OCT-GAN apparatus 130 may exploit the homeomorphic characteristic of NODEs through the generation unit 330 to transform z® c onto another latent space while preserving the (semantic) topology of the initial latent space. The OCT-GAN apparatus 130 may have an advantage because i) a data distribution in tabular data is irregular and difficult to directly capture and ii) by finding an appropriate latent space, the generator may generate better samples. In addition, the OCT-GAN apparatus 130 may smoothly perform the operation of interpolating noisy vectors under a given fixed condition.

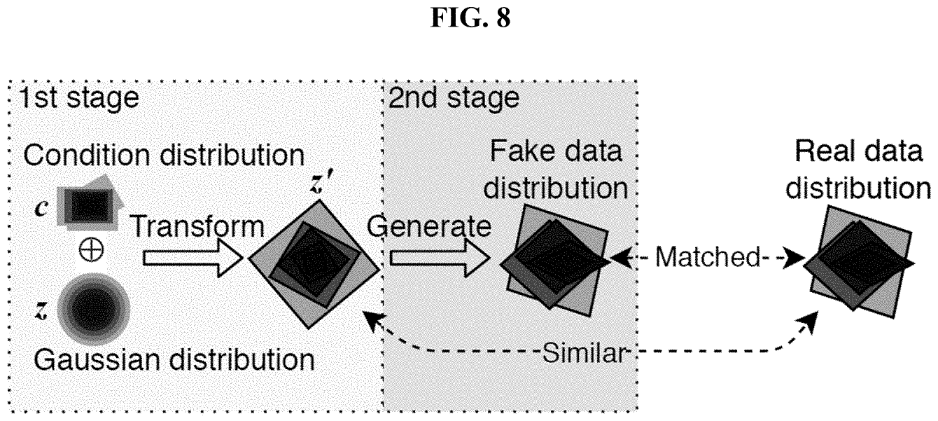

Accordingly, the entire generation process performed in the OCT-GAN apparatus 130 may be separated into the following two stages as in FIG. 8: 1) transforming the initial input space into another latent space (potentially close to a real data distribution) while maintaining the topology of the input space, and 2) the remaining generation process finds a fake distribution matched to the real data distribution.

The tabular data preprocessing unit 310 may preprocess tabular data including discrete columns and continuous columns. More specifically, tabular data may include two types of columns. In other words, the two types of columns may be a discrete column and a continuous column. In this connection, the discrete column may be denoted as {D₁, D₂, . . . , D_{N}_{_{D}}}, and the continuous column may be denoted as {C₁, C₂, . . . , C_{N}_{_{C}}}.

In an embodiment, the tabular data preprocessing unit 310 may transform discrete values in a discrete column into one-hot vectors, and preprocess continuous values in a continuous column with a mode-specific normalization. GANs generating tabular data frequently suffer from mode collapse and irregular data distribution, thus making it difficult to achieve the desired results. By specifying modes before training, the mode-specific normalization may alleviate the problems. The i-th raw sample rᵢ (a row or record in the tabular data) may be written as d_{i,1}⊕d_{i,2} ⊕ . . . ⊕d_{i,N}_{_{D}}⊕c_{i,1}⊕c_{i,2}⊕ . . . ⊕c_{i,N}_{_{C}}, where d_{i,j} (or c_{i,j}) is a value in column Dⱼ (or column Cj).

In an embodiment, the tabular data preprocessing unit 310 may preprocess the raw sample rᵢ to xᵢ through the following three stages. In particular, the tabular data preprocessing unit 310 may generate a normalized value and a mode value by applying each of the continuous values to a Gaussian mixture and normalizing the same with its fitted standard deviation, merge a one-hot vector, a normalized value Pᵣ_{ⱼ}(c_{i,j})=Σₖ₌₁ⁿ^{ⱼ}w_{j,k}N(c_{i,j}; u_{j,k}, σ_{j,k}) e and a mode value, and transform raw data in tabular data into mode-based information.

More specifically, in stage 1, each discrete values {d_{i,1}, d_{i,2}, . . . , d_{i,N}_{_{D}}} may be transformed to one-hot vector {d_{i,1}, d_{i,2}, . . . , d_{i,N}_{_{D}}}. In addition, in stage 2, using the variational Gaussian mixture (VGM) model, each continuous column Cⱼ may be fitted to a Gaussian mixture. The fitted Gaussian mixture is Pᵣ_{ⱼ}(c_{i,j})=Σₖ₌₁ⁿ^{ⱼ}w_{j,k}N(c_{i,j}; u_{j,k}, σ_{j,k}), where nⱼ is the number of modes (i.e., the number of Gaussian distributions) in columns Cⱼ, and w_{j,k}, μ_{j,k} and σ_{j,k} are a fitted weight, mean and standard deviation of k-th Gaussian distribution.

In addition, in stage 3, with a probability of

$${P}_{{r}_{j}} ( k ) = \frac{{w}_{j , k} N ( {c}_{i , j} ; {u}_{j , k} , {σ}_{j , k} )}{{\sum }_{p = 1}^{{n}_{j}} {w}_{j , p} N ( {c}_{i , j} ; {u}_{j , p} , {σ}_{j , p} )} ,$$

an appropriate mode k may be sampled for c_{i,j}. Then, c_{i,j} is normalized from the mode k with its fitted standard deviation, and the normalized value α_{i,j} and the mode information β_{i,j} may be saved. For example, when there are 4 modes and the third mode, i.e., k=3 is picked, then α_{i,j} is

$$\frac{{c}_{i , j} - {μ}_{3}}{4 {σ}_{3}}$$

and β_{i,j} is [0, 0, 1, 0].

As a result, rᵢ may be transformed to xᵢ which is denoted as Equation 3 as follows:

xᵢ=α_{i,1}⊕β_{i,1}⊕ ⋅ ⋅ ⋅ ⊕α_{i,N}_{_{c}}⊕β_{i,N}_{_{c}}⊕d_{i,1}⊕ ⋅ ⋅ ⋅ ⊕d_{i,N}_{_{D}} [Equation 3]

Herein, in xᵢ, the detailed mode-based information of rᵢ may be specified. The discrimination unit 350 and the generation unit 330 of the OCT-GAN apparatus 130 may use xᵢ instead of rᵢ for its clarification on modes. However, xᵢ may be readily changed to rᵢ, once generated, using the fitted parameters of the Gaussian mixture.

The NODE-based generation unit 330 may generate a fake sample by reading a condition vector and a noisy vector generated based on the preprocessed tabular data. In other words, the OCT-GAN apparatus 130 may implement a conditional GAN. In this connection, the condition vector may be defined as c=c₁⊕ ⋅ ⋅ ⋅ ⋅ ⋅ ⋅ ⊕c_{N}_{_{D}}, where cᵢ may be either a zero vector or a random one-hot vector of the i-th discrete column.

In addition, the NODE-based generation unit 330 may randomly decide s∈{1, 2, . . . , N_{D}} and only cₛ is a random one-hot vector and for all other i≠s, cᵢ is a zero vector. In other words, the NODE-based generation unit 330 may specify a discrete value in the s-th discrete column.

Given an initial input p(0)=z⊕c, the NODE-based generation unit 330 may feed it into an ODE layer to transform into another latent vector. In this connection, the transformed vector may be denoted by z′. For the transformation, the NODE-based generation unit 330 may use an ODE layer which is denoted as Equation 4 and is independent from the ODE layer in the discriminator as follows:

z′=p(1)=p(0)+∫₀¹g(p(t),t;θ_{g})dt [Equation 4]

Herein, the integral time may be fixed to [0, 1] because any ODE in [0,w], w>0, with G may be reduced into a unit-time integral with g′ by letting

$${g}^{′} = \frac{g ( p ( t ) , t ; {θ}_{g} )}{w} .$$

In an embodiment, the NODE-based generation unit 330 may obtain the condition vector from a condition distribution, obtain the noisy vector from a Gaussian distribution, and generate the fake sample by merging the condition vector and the noisy vector. In an embodiment, the NODE-based generation unit 330 may perform homeomorphic mapping on the merged vector of the condition vector and the noisy vector to generate the fake sample within a range that matches a distribution of a real sample.

First, an ODE may be a homeomorphic mapping. In addition, GANs may typically use a noisy vector sampled from a Gaussian distribution, which is known as sub-optimal. Accordingly, the prescribed transformation may be needed.

The Grönwall-Bellman inequality states that given an ODE ϕₜ and its two initial states p₁(0)=x and p2(0)=x+δ, there exists a constant τ satisfying ∥ϕₜ(x)−ϕₜ(x+δ)∥≤exp(τ)∥δ∥. In other words, two similar input vectors with small 6 may be mapped to close to each other within a boundary of exp(τ)∥δ∥.

In addition, the NODE-based generation unit 330 does not extract z′ from intermediate time points so the generator's ODE may learn a homeomorphic mapping. Accordingly, the NODE-based generation unit 330 may maintain the topology of the initial input vector space. The initial input vector p(0) may contain non-trivial information on what to generate, e.g., condition, so the NODE-based generation unit 330 may maintain the relationships among initial input vectors while transforming the initial input vectors onto another latent vector space suitable for generation.

FIG. 8 illustrates an example of a two-stage approach where i) the ODE layer finds a balancing distribution between the initial input distribution and the real data distribution and ii) the following procedures generate realistic fake samples. In particular, the transformation according to the present disclosure may make the interpolation of synthetic samples smooth, i.e., given two similar initial inputs, two similar synthetic samples may be generated by the generator according to the present disclosure.

The NODE-based generation unit 330 may implement a generator equipped with an optimal transformation learning function, and may be denoted as Equation 5 as follows:

p(0)=z⊕c

z′=p(0)+∫₀¹g(p(t),t;θ_{g})dt

h(0)=z′⊕ReLU(BN(FC1(z′)))

h(1)=h(0)⊕ReLU(BN(FC2(h(0))))

\hat{α}ᵢ=Tanh(FC3(h(1))),1≤i≤N_{c}

\hat{β}ᵢ=Gumbel(FC4(h(1))),1≤i≤N_{c}

\hat{d}ⱼ=Gumbel(FC5(h(1))),1≤j≤N_{d}, [Equation 5]

where Tanh is the hyperbolic tangent, and Gumbel is the Gumbel-softmax to generate one-hot vectors. The ODE function g(p(t),t;θ_{g}) may be defined as Equation 6 as follows:

$$Leaky ( FC 13 ( ⋯ Leaky ( FC 6 ( Norm ( p ( t ) ) ⊕ t ) ) ⋯ ) ) , \\ where Norm ( p ) = \frac{p}{{‖ p ‖}^{2}} .$$

The NODE-based generation unit 330 may specify a discrete value in a discrete column as a condition. Thus, it is required that \hat{d}ₛ=cₛ, and a cross-entropy loss may be used to enforce the match, denoted [symbol] =H(cₛ, \hat{d}ₛ). As another possible example, the NODE-based generation unit 330 may copy cₛ to \hat{d}ₛ.

The NODE-based discrimination unit 350 may receive a sample composed of a real sample or a fake sample of the preprocessed tabular data and perform continuous trajectory-based classification. In other words, the NODE-based discrimination unit 350 may consider the trajectory of h(t), where t∈[0,tₘ], when predicting whether an input sample x is real or fake. The NODE-based discrimination unit 350 may be implemented as an ODE-based discriminator that outputs D(x) given a (pre-processed or generated) sample x, and may be defined as Equation 7 as follows:

$$\begin{matrix}h ( 0 ) = Drop ( Leaky ( FC 2 ( Drop ( Leaky ( FC 1 ( x ) ) ) ) ) ) \\ h ( {t}_{1} ) = h ( 0 ) + {\int }_{0}^{{t}_{1}} f ( h ( 0 ) , t ; {θ}_{f} ) dt \\ h ( {t}_{2} ) = h ( {t}_{1} ) + {\int }_{{t}_{1}}^{{t}_{2}} f ( h ( {t}_{1} ) , t ; {θ}_{f} ) dt \\ ⋮ \\ h ( {t}_{m} ) = h ( {t}_{m - 1} ) + {\int }_{{t}_{m - 1}}^{{t}_{m}} f ( h ( {t}_{m - 1} ) , t ; {θ}_{f} ) dt \\ {h}_{x} = h ( 0 ) ⊕ h ( {t}_{1} ) ⊕ h ( {t}_{2} ) ⊕ ⋯ ⊕ h ( {t}_{m} ) \\ D ( x ) = F C 5 ( L eaky ( FC 4 ( L eaky ( FC 3 ( {h}_{x} ) ) ) ) ) ,\end{matrix} \qquad [ Equation 7 ]$$

where ⊕ means the concatenation operator, Leaky is the leaky ReLU, Drop is the dropout, and FC is the fully connected layer. The ODE function f(h(t),t;θ_{f}) may be defined as Equation 8 as follows:

ReLU(BN(FC7(ReLU(BN(FC6(ReLU(BN(h(t)))⊕)))))), [Equation 8]

where BN is the batch normalization and ReLU is the rectified linear unit.

In an embodiment, the NODE-based discrimination unit 350 may perform feature extraction of the input sample and generate a plurality of continuous trajectories through Ordinary Differential Equations (ODE) on the feature-extracted sample.

The trajectory of h(t) is continuous in NODEs. However, it may be difficult to consider continuous trajectories in training GANs. Accordingly, to discretize the trajectory of h(t), t₁, t₂, . . . , tₘ may be trained and m may be a hyperparameter in the corresponding model. In addition, in Equation 7 above, h(t₁), h(t₂), . . . , h(tₘ) may share the same parameter θ_{f}, which means they constitute a single system of ODEs but may be separated for the purpose of discretization. After letting

$${a}_{t} ( t ) = \frac{d ℒ}{dt} ,$$

the following gradient definition (derived from the adjoint sensitivity method) may be used to train tᵢ for all i. In other words, the gradient of loss L for tm may be defined as Equation 9 as follows.

$${∇}_{{t}_{m}} ℒ = \frac{d ℒ}{d {t}_{m}} = {a}_{h} ( {t}_{m} ) f ( h ( {t}_{m} ) , {t}_{m} ; {θ}_{f} ) \qquad [ Equation 9 ]$$

For the same reason above,

$${∇}_{{t}_{i}} ℒ = \frac{d ℒ}{{dt}_{i}} = {a}_{h} ( {t}_{i} ) f ( h ( {t}_{i} ) {t}_{i} ; {θ}_{f} )$$

where i<m. However, it may not be necessary to save any intermediate adjoint states for space complexity purposes and calculate the gradient with a reverse-mode integral as Equation 10 as follows:

$${∇}_{{t}_{i}} ℒ = {a}_{h} ( {t}_{m} ) f ( h ( {t}_{m} ) , {t}_{m} ; {θ}_{f} ) - {\int }_{{t}_{m}}^{{t}_{i}} {a}_{h} ( t ) \frac{\partial f ( h ( t ) , t ; {θ}_{f} )}{\partial t} dt \qquad [ Equation 10 ]$$

The NODE-based discrimination unit 350 may store only one adjacent state aₕ(tₘ) and calculate ∇ₜ_{ᵢ} [symbol] based on the two functions f and aₕ(t).

In an embodiment, the NODE-based discrimination unit 350 may generate a merged trajectory hx by merging a plurality of continuous trajectories, and classify a sample as real or fake through the merged trajectory.

Typically, the last hidden vector h(tₘ) is used for classification. However, the NODE-based discrimination unit 350 may use the entire trajectory for classification. When using only the last hidden vector, all needed information for classification should be correctly captured in it. However, the NODE-based discrimination unit 350 may easily distinguish even two similar last hidden vectors when the intermediate trajectories are different at least at a value of t.

In addition, the NODE-based discrimination unit 350 may train tᵢ, which further improves the efficacy by finding key time points to distinguish trajectories. Training tᵢ is impossible in usual neural networks because their layer constructions are discrete. FIG. 7(B) illustrates such an example that only the NODE-based discriminator with learnable intermediate time points may correctly classify, and FIG. 7(c) illustrates that the method may address the problem of the limited learning representation of NODEs.

More specifically, in FIG. 7(B), suppose that the two red/blue trajectories from t₀ to tₘ are all similar except around tᵢ. Because such distinguishing time points are trained, the trajectory-based classification according to the present disclosure may correctly classify them. In FIG. 7(C), the red and blue trajectories do not cross each other and may be learned by NODEs. However, by taking the blue hidden vector at tᵢ and the red hidden vector at tₘ, the mutual positions may be swapped, which may be impossible in FIG. 7(B). Accordingly, the trajectory-based classification according to the present disclosure is necessary to improve NODEs.

The control unit 370 may control the overall operation of the OCT-GAN apparatus 130, and manage a control flow or data flow between the tabular data preprocessing unit 310, the NODE-based generation unit 330, and the NODE-based discrimination unit 350.

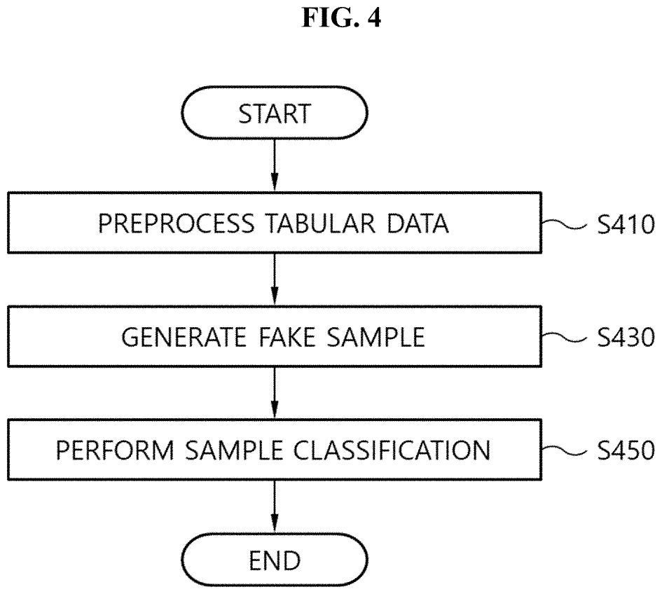

FIG. 4 is a flowchart illustrating a neural ODE-based conditional tabular generative adversarial network method according to the present disclosure.

Referring to FIG. 4, the OCT-GAN apparatus 130 may preprocess tabular data composed of a discrete column and a continuous column through the tabular data preprocessing unit 310 (stage S410). The OCT-GAN apparatus 130 may generate a fake sample by reading a condition vector and a noisy vector generated based on the preprocessed tabular data through the NODE-based generation unit 330 (stage S450). The OCT-GAN apparatus 130 may receive a sample composed of a real sample or a fake sample of the preprocessed tabular data and perform continuous trajectory-based classification through the NODE-based discrimination unit 350 (stage S450).

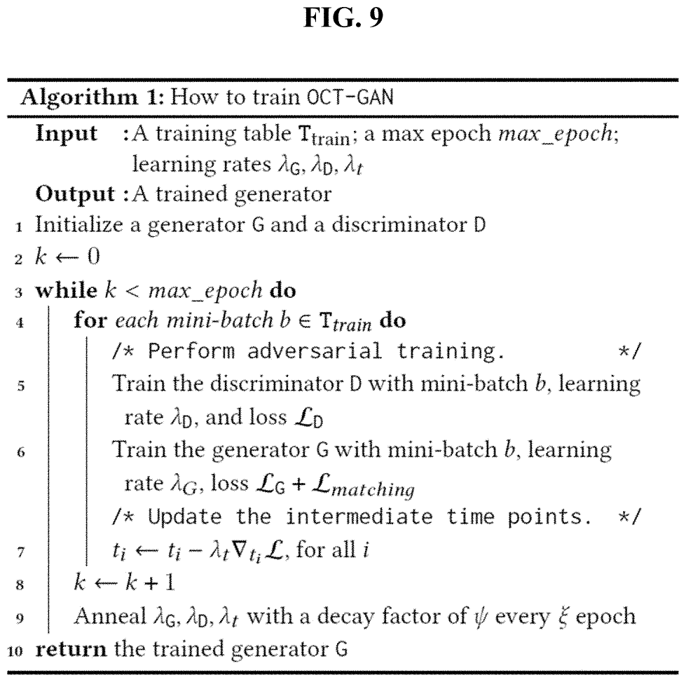

The OCT-GAN apparatus 130 according to the present disclosure may train OCT-GAN using the loss in Equation 1 above in conjunction with [symbol] and the training algorithm is illustrated in FIG. 9. To train OCT-GAN, a real table Tₜᵣₐᵢₙ, and a maximum epoch number max_epoch are needed. After creating a mini-batch b (line 4 of FIG. 9), the OCT-GAN apparatus 130 may perform the adversarial training (lines 5 and 6 of FIG. 9), followed by updating tᵢ with the custom gradient calculated by the adjoint sensitivity method (line 7 of FIG. 9).

The space complexity to calculate ∇ₜ_{ᵢ} [symbol] may be O(1). Calculating ∇ₜ_{ᵢ} [symbol] may subsume the computation of ∇ₜ_{ᵢ} [symbol] , where t₀≤tⱼ<tᵢ≤tₘ. While solving the reverse-mode integral from tₘ to t₀, the OCT-GAN apparatus 130 may retrieve

$$\frac{d ℒ}{{dt}_{i}}$$

for all i. Accordingly, the space complexity to calculate all the gradients is O(m) at line 7 of FIG. 9, which is additional overhead incurred by the method according to the present disclosure.

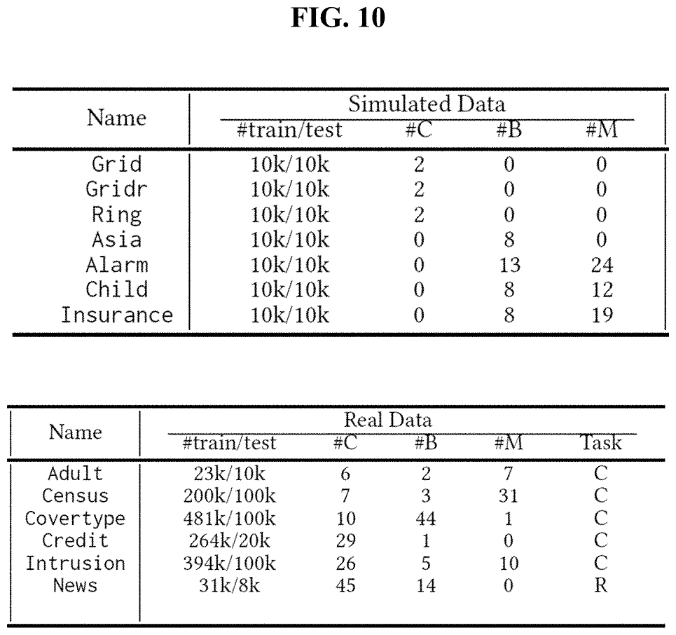

Hereinafter, referring to FIGS. 10 to 14, the experimental details on the neural ODE-based conditional tabular generative adversarial network method according to the present disclosure will be described.

Specifically, the experimental environments and results for likelihood estimation, classification, regression, clustering, and so on will be described.

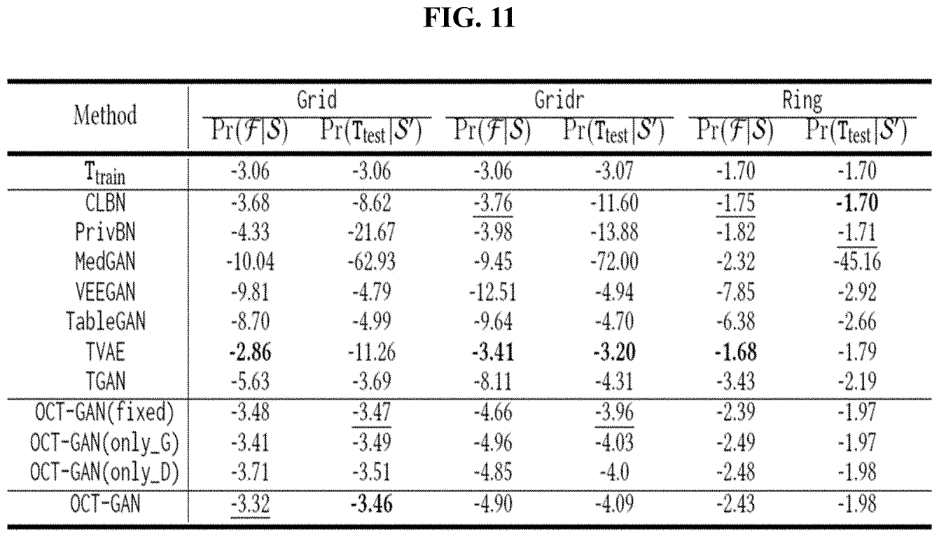

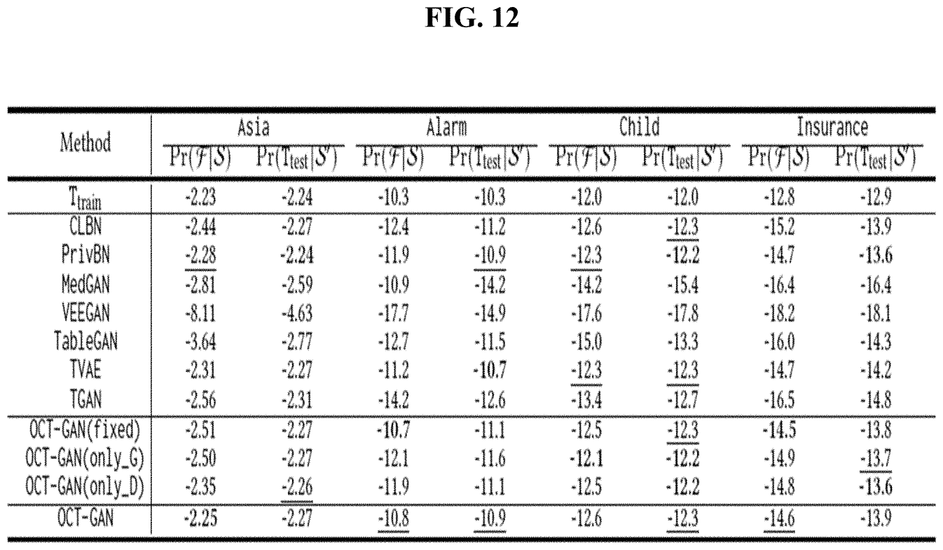

FIGS. 11 and 12 illustrate all likelihood estimation results. CLBN and PrivBN may show fluctuating performance. CLBN and PrivBN may be good in Ring and Asia, respectively, while PrivBN may show poor performance in Grid, and Gridr. TVAE may show good performance for Pr(F|S) in many cases but relatively worse performance than others for Pr(Tₜₑₛₜ|S′) in Grid and Insurance, which may mean mode collapse. At the same time, TVAE may show nice performance for Gridr. All in all, TVAE may show reasonable performance in these experiments.

Among many GAN models except OCT-GAN, TGAN and TableGAN may show reasonable performance, and other GANs may show inferior performance, e.g., −14.3 for TableGAN vs. −14.8 for TGAN vs. −18.1 for VEEGAN in Insurance with Pr(Tₜₑₛₜ|S′). However, all these models may be significantly outperformed by the proposed OCT-GAN. In all cases, OCT-GAN may show better performance than TGAN, the state-of-the-art GAN model.

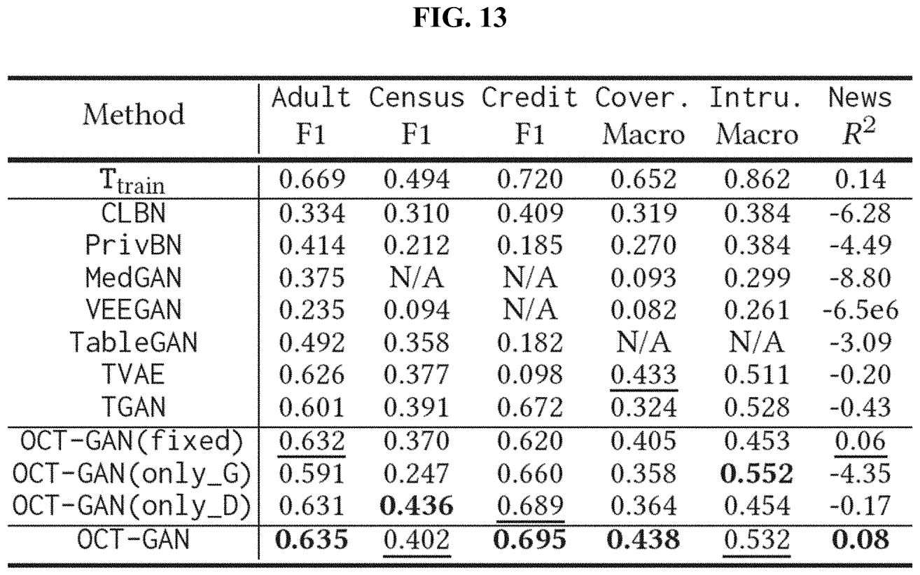

FIG. 13 illustrates the classification results. CLBN and PrivBN may not show any reasonable performance in the experiments even though their likelihood estimation experiments with simulated data are not bad. All their (Macro) F-1 scores may fall into the category of worst-case performance, which proves potential intrinsic differences between likelihood estimation and classification—data synthesis with good likelihood estimation may not necessarily mean good classification. TVAE may show reasonable scores in many cases. In Credit, however, its score may be unreasonably low. This may corroborate the intrinsic difference between likelihood estimation and classification. Many GAN models except TGAN and OCT-GAN may show low scores in many cases, e.g., an F-1 score of 0.094 by VEEGAN in Census. Due to severe mode collapse in F, it is not possible to properly train classifiers in some cases and their F-1 scores may be marked with ‘N/A’. However, the OCT-GANs according to the present disclosure, including its variations, may significantly outperform all other methods in all datasets.

In FIG. 13, all methods except OCT-GAN may show unreasonable accuracy. The original model, trained with Tₜᵣₐᵢₙ, may show an R² score of 0.14 and the OCT-GAN according to the present disclosure may show a score close thereto. Only OCT-GAN and the original model, marked with Tₜᵣₐᵢₙ, may show positive scores.

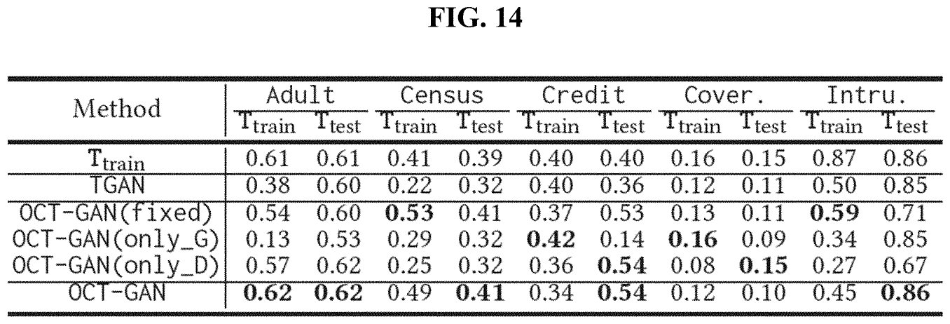

FIG. 14 illustrates the results by TGAN and OCT-GAN, the top-2 models for classification and regression, where OCT-GAN may outperform TGAN in almost all cases.

To show the efficacy of key design points in the model according to the present disclosure, the comparison experiments with the following comparative models may be performed:

(1) In OCT-GAN(fixed), tᵢ may not be trained but set to tᵢ=i/m, 0≤i≤m, i.e., evenly dividing the range [0, 1] into t₀=0, t₁=1/m, . . . , tₘ=1.

(2) In OCT-GAN(only_G), an ODE layer may be added only to the generator and the discriminator may not have the ODE layer. In Equation 7 above, D(x) may be set to FC5(Leaky(FC4(Leaky(FC3(h(0))))))).

(3) In OCT-GAN(only_D), an ODE layer may be added only to the discriminator and z⊕c may be fed directly into the generator.

FIGS. 11 to 14 illustrate the comparative models' performance. In FIGS. 11 and 12, those comparative models may show better likelihood estimations than the full model, OCT-GAN, in several cases. However, the margins between the full model and the comparative models may be relatively small (even when the ablation study models are better than the full model).

For the classification and regression experiments in FIG. 13, however, it is possible to observe non-trivial differences among them in several cases. In Adult, for instance, OCT-GAN(only_G) may show a much lower score than other models. By this, it is possible to know that in Adult, the ODE layer in the discriminator plays a key role. OCT-GAN(fixed) is almost as good as OCT-GAN, but learning intermediate time points further improves, i.e., 0.632 of OCT-GAN(fixed) vs. 0.635 of OCT-GAN. Accordingly, it is crucial to use the full model, OCT-GAN, considering the high data utility in several datasets.

Tabular data synthesis is an important topic of web-based research. However, it is hard to synthesize tabular data due to its irregular data distribution and mode collapse. The neural ODE-based conditional tabular generative adversarial network method according to the present disclosure may implement a NODE-based conditional GAN, called OCT-GAN, designed to address all those problems. The method according to the present disclosure may provide the best performance in many cases of the classification, regression, and clustering experiments.

Although the present disclosure has been described with reference to the preferred embodiment of the present disclosure, it will be appreciated by those skilled in the pertinent technical field that various modifications and variations may be made without departing from the scope and spirit of the present disclosure as described in the claims below.

[Detailed Description of Main Elements]

| | |
|---|---|
| 100: OCT-GAN system | |
| 110: user terminal | 130: OCT-GAN apparatus |
| 150: database | |
| 210: processor | 230: memory |
| 250: user input/output unit | 270: network input/output unit |
| 310: tabular data preprocessing unit | 330: NODE-based generation unit |
| 350: NODE-based discrimination unit | 370: control unit |

What is claimed is:

1. A Neural ODE-based Conditional Tabular Generative Adversarial Network (OCT-GAN) apparatus, comprising:
a tabular data preprocessing unit for preprocessing tabular data composed of a discrete column and a continuous column;
a Neural Ordinary Differential Equation (NODE)-based generation unit for generating a fake sample by reading a condition vector and a noisy vector generated based on the preprocessed tabular data; and
a NODE-based discrimination unit for receiving a sample composed of a real sample or the fake sample of the preprocessed tabular data and performing continuous trajectory-based classification.

2. The apparatus of claim 1, wherein the tabular data preprocessing unit transforms discrete values in the discrete column into a one-hot vector and preprocess continuous values in the continuous column with mode-specific normalization.

3. The apparatus of claim 2, wherein the tabular data preprocessing unit generates a normalized value and a mode value by applying a Gaussian mixture to each of the continuous values and normalizing the same with a corresponding standard deviation.

4. The apparatus of claim 3, wherein the tabular data preprocessing unit transforms raw data in the tabular data into mode-based information by merging the one-hot vector, the normalized value, and the mode value.

5. The apparatus of claim 1, wherein the NODE-based generation unit obtains the condition vector from a condition distribution, obtains the noisy vector from a Gaussian distribution, and generates the fake sample by merging the condition vector and the noisy vector.

6. The apparatus of claim 5, wherein the NODE-based generation unit performs homeomorphic mapping on the merged vector of the condition vector and the noisy vector to generate the fake sample within a range that matches a distribution of a real sample.

7. The apparatus of claim 1, wherein the NODE-based discrimination unit performs feature extraction of the input sample and generates a plurality of continuous trajectories through Ordinary Differential Equations (ODE) on the feature-extracted sample.

8. The apparatus of claim 7, wherein the NODE-based discrimination unit generates a merged trajectory hx by merging the plurality of continuous trajectories, and classifies the sample as real or fake through the merged trajectory.

9. A Neural ODE-based Conditional Tabular Generative Adversarial Network (OCT-GAN) method, comprising:
a tabular data preprocessing stage of preprocessing tabular data composed of a discrete column and a continuous column;
a Neural Ordinary Differential Equation (NODE)-based generation stage of generating a fake sample by reading a condition vector and a noisy vector generated based on the preprocessed tabular data; and
a NODE-based discrimination stage of receiving a sample composed of a real sample or the fake sample of the preprocessed tabular data and performing continuous trajectory-based classification.

10. The method of claim 9, wherein the tabular data preprocessing stage includes transforming discrete values in the discrete column into a one-hot vector and preprocessing continuous values in the continuous column with mode-specific normalization.

11. The method of claim 9, wherein the NODE-based generation stage includes obtaining the condition vector from a condition distribution, obtaining the noisy vector from a Gaussian distribution, and generating the fake sample by merging the condition vector and the noisy vector.

12. The method of claim 11, wherein the NODE-based generation stage includes performing homeomorphic mapping on the merged vector of the condition vector and the noisy vector to generate the fake sample within a range that matches a distribution of a real sample.

13. The method of claim 9, wherein the NODE-based discrimination stage includes performing feature extraction of the input sample and generating a plurality of continuous trajectories through Ordinary Differential Equations (ODE) on the feature-extracted sample.
